(19) United States
(12) Patent Application Publication
(10) Pub. No.: US 2008/0016176 A1
(43) Pub. Date: Jan. 17, 2008

(54) SYSTEM FOR DEVELOPMENT OF GAMES FOR MOBILE DEVICES AND DISTRIBUTION THEREOF

(76) Inventor: Ofir Leitner, Jerusalem (IL)

Correspondence Address: WEISS & MOY PC, 4204 NORTH BROWN AVENUE, SCOTTSDALE, AZ, 85251, US

(21) Appl. No.: 11/457,405

(22) Filed: Jul. 13, 2006

(51) Int. Cl. G06F 15/16

(52) U.S. Cl. 709/217

(57) ABSTRACT

Client and server components enable simplified development of games or other software applications and deployment on mobile devices of varying types without re-writing. The client runs on the mobile device and includes an engine or game engine interacting with the mobile device through a code layer specific to the particular mobile device, where the parameters of the game or other application itself are determined by a game file or data file, and the client also includes a management system for downloading games or other applications. The server runs on a general purpose computer and includes both a download and distribution server interacting with the client, and a game or application editor that can be accessed via a web browser. The editor creates and edits data files, including selecting types of games or other applications, designing sprites and tiles, and also selecting rules and parameters for a game or other application.

### BACKGROUND OF THE INVENTION

1. Field of the Invention

The present invention relates to development and distribution of games to run on mobile devices, such as mobile phones.

2. Description of the Background

Mobile telephones have become not only ubiquitous, but also extremely sophisticated, often including many other functions other than merely the ability to function as a telephone. For example, built-in cameras and the ability to send and receive e-mail and/or text messages are often included. Some are even combined with a Portable Digital Assistant. In addition, many such mobile devices include the ability to download and run games or other software.

Many different makes and models of mobile devices exist, and it is desirable to be able to run the same software on different devices, to save time and effort coding and compiling many different versions. One way to do this is to employ a virtual machine and to compile applications to run on that virtual machine, so that only the virtual machine itself has to be coded and compiled for each platform. Probably the best known example of this approach uses the Java virtual machine and the Java programming language, developed by Sun Microsystems.

Sun Microsystems has developed J2ME (Java 2 Platform, Micro Edition) to extend the benefits of Java to devices with a small footprint, such as mobile phones, PDAs, TV set-top boxes and printers. Hence, in theory, a game or other software application could be written and compiled once for J2ME and run on a variety of mobile devices. However, there are a few problems that make this more challenging, as will be discussed further.

Firstly, Different profiles exist in J2ME. Sun has defined two profiles for J2ME based mobile phones. The older one is called MIDP (Mobile Information Device Profile) 1.0 and has limited features in terms of graphics manipulation, UI widgets, communications etc. The newer one is called MIDP 2.0 and is much more advanced and includes more natural support for gaming needs. Although an MIDP 1.0 client could be written that would run on MIDP 2.0 devices as well (as these should be backwards-compatible), such a client couldn't use the special features that MIDP 2.0 offers, and games would run slower and may not look as good as other games written for the same mobile devices.

Next, support for optional APIs must be considered. In addition to these two profiles, Sun offers additional standard APIs to handle Multimedia (Mobile Media API, or MMA), Messaging (Wireless Messaging API, or WMA) and more. Not all devices support these APIs, and an application that uses a certain API would not run on a phone that doesn't support that API. Although it would be possible to write a “lowest common denominator” application that didn't use any of the optional APIs, this would not take advantage of multimedia or messaging features.

Further, non-standard (device specific) APIs have to be considered. In addition to Sun's formal specs and APIs, the mobile device vendors themselves (i.e. Nokia, Motorola etc.) also add proprietary APIs to their phones. Usually these APIs allow the developer to utilize new technologies, or just supply a more native interface to the device hardware. The problem is that sometimes in order to create an application/game it is necessary to use these APIs. For example, native APIs offer increased speed over pure J2ME applications, and failure to take advantage of native APIs may mean that a game will run too slowly. A good example of this is NokiaUI, which is an API that provides accelerated graphics performance and enables some MIDP 2.0-like graphics manipulations in MIDP 1.0 devices.

In addition, there is the problem of partial API implementation. It is not uncommon to find J2ME virtual machines that simply do not implement certain methods, or that implement them incorrectly. Sometimes the vendors are aware of this and mention it in their API documentations, and sometimes the developers discover it. So it is possible to find that two devices that are intended to implement the same profile, same standard APIs and same proprietary APIs, may still not behave identically.

It should be noted that all of these issues are major ones, and the direct consequence is that it may not be possible to run an application that was written for one device on another one (unless the application uses the lowest common denominator, and even then there is no certainty that it will run correctly or even run at all).

In addition to these problems of developing applications for mobile devices, there is the additional problem that developing software applications usually requires the ability to write programs in at least one programming language, such as Java, for example. This tends to limit most users to software applications that have been professionally developed. A need exists for end users to be able to devise their own games, in which they set the rules and decide on the appearance of the game. End users may learn the basics of programming, but are rarely able to master the skills necessary to write games, which are one of the more difficult types of application to write. Many attempts have been made to simplify programming, including many types of visual programming environments, but none of these is entirely satisfactory for writing games.

Mobile devices such as mobile phones also suffer from a number of additional problems, as discussed below.

By their very nature, mobile device have restricted storage space. Unlike PCs, which nowadays have tens of GB to store information, most popular mobile devices have only hundreds of KB. Some advanced devices may already have several MB, but have not yet reached the mass market. Because of this, in most current or older phones there is a limitation of 64 KB per application.

A further restriction is small heap size. The available memory that the application can use is very small. This means that it is not possible to load many images into the memory but rather only the necessary images for the displayed screen. Also, all the instances of objects that are not in use must be dropped, and it is not possible to rely upon the luxury of letting the garbage collector built into languages such as Java do its work, but instead code must be written to destroy unused instances of objects. Again, this requires a different kind of coding which is not normally seen in the PC Java environment.

Processor speed represents yet another limitation of mobile devices. The speed of mobile processors is not what one is used to in modern PCs, and the same goes for the graphics processor (there are no “accelerator-cards” in most mobile devices).

These and other problems are overcome by the present invention, as will be described below, with reference to the several views, in which like reference numerals represent like elements.

### SUMMARY

According to a preferred embodiment of the present invention, client and server components are provided to enable simplified development of games or other software applications to be deployed on mobile devices of widely varying types without re-writing the applications.

The client runs on the mobile device and includes a game engine interacting with the mobile device through a code layer, where the code layer is specific to the particular mobile device, and the parameters of the game itself are determined by a game file. In addition, the client includes a game management system that interacts with the server to download games.

The server runs on a suitable general purpose computer and includes both a download and distribution server that interacts with the client, and a game editor that developers and users can interact with via, for example, a web browser. The game editor creates and edits game files, providing a selection between types of games, design tools for sprites and tiles for use in the game, and also selection of rules and parameters of the game.

### BRIEF DESCRIPTION OF THE DRAWINGS

FIG. 1 is a view of the system architecture.

FIG. 2 shows the components of the client application.

FIG. 3 is a login screen.

FIG. 4 shows community pages displaying games.

FIG. 5 shows the game world selector.

FIG. 6 shows the game editor.

FIG. 7 shows editing object properties.

FIG. 8 shows the sprite editor.

FIG. 9 illustrates tile maps.

FIG. 10 shows creating a two-dimensional array that maps tile numbers into a tiled background.

FIG. 11 shows editing a tile set.

FIG. 12 shows editing levels

FIG. 13 illustrates the window shown when adding a layer.

FIG. 14 shows editing fonts.

FIG. 15 shows editing a status bar.

FIG. 16 shows capturing an image of a face.

### DETAILED DESCRIPTION OF THE INVENTION

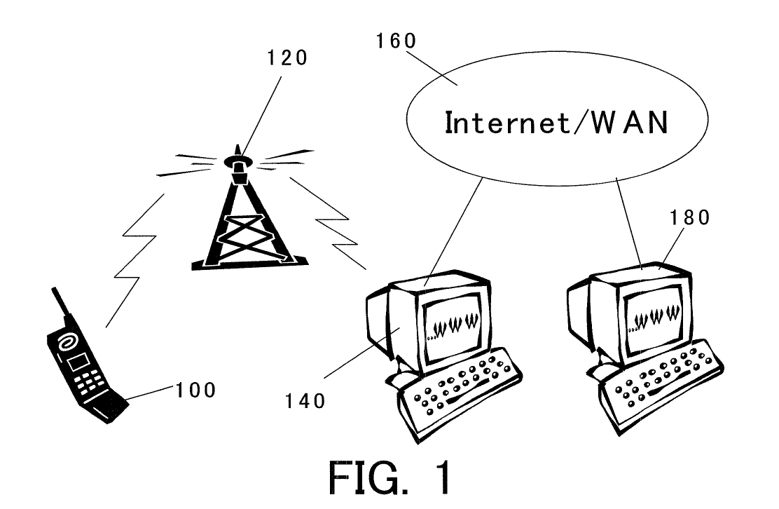

In the preferred embodiment shown in FIG. 1, a mobile device 100 is connected via a mobile communications network symbolized by tower 120 to a server 140, and the server 140 is connected to a wide area network 160, such as the Internet. A user may also connect to the server 120 via wide area network 160 using a personal computer 180 using suitable web browser software, for example.

In a preferred embodiment, the client (on the mobile phone or other mobile device) is built in J2ME, a subset of Java designed for mobile devices. The client contains three elements: an abstraction layer, a game engine, and a game management system, described in further detail below. In this example, the client application runs games on a mobile device using J2ME, but it will be appreciated by those skilled in the art that the invention can be applied to other types of software application on other types of devices, and that other programming languages may be employed without departing from the scope of the invention.

The abstraction layer is provided for compatibility with multiple makes and models of mobile devices. To allow compatibility to all devices a layer had to be created that on the one hand talks to the device in its own language, but on the other hand runs the same games in the same way on every device (within the limitations of that particular device).

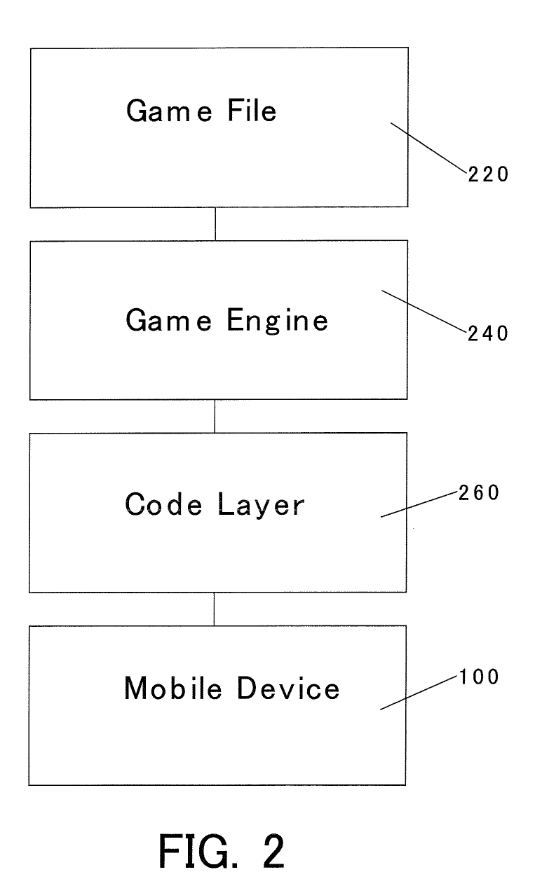

To solve this issue the concept was developed of separation between a code layer which is custom tailored to each device, and a standard game file format (for all devices) that contains all the graphics, sounds, rules and other game objects and elements. As shown in FIG. 2, the game file 220 supplies game parameters to game engine 240, which accesses the mobile device 100 via code layer 260.

Code is preferably written for a standard MIDP 2.0 device, and when support for a new device is needed, the code is adapted to use the specific APIs that this specific device uses. This is preferably performed by means of a “builder” that knows to cut/add certain code parts in builds for certain devices. The builder allows device support to be added rapidly by cutting/adding relevant segments of code that have already been written for other devices, and if needed also writing new segments of code (which can be reused later).

For example, to allow the support of MIDP 1.0 devices, wrapper classes have been written that have the same name and methods as MIDP 2.0 classes, but actually are just an interface that uses standard MIDP 1.0 methods. In this way, it is unnecessary to rewrite the entire code base for MIDP 1.0, as a MIDP 2.0 “simulation package” can be added when it is desired to create a MIDP 1.0 build.

The game engine is central to the client application. It has to be generic on the one hand but support advanced features on the other hand. The engine receives a game data file that contains all the game's elements (graphics, sounds, rules etc.) and then runs the game.

The tasks carried out by the game engine include the following:
Placing all the sprites in their positions and updating them all the time.
Playing all the animations (The different frames of the sprites, background).
Playing the music and sound effects.
Interpreting the user's keyboard use into real actions.
Maintaining the “game world” physical rules (Gravitation, acceleration etc.)
Handling the enemy AI (Moving enemies by different strategies based on what is going on the screen).
Performing constant checks to detect collisions between sprites.
Controlling the player's and the enemies' inventory, firearms etc.
Displaying complex backgrounds.

This is just a partial list, since the engine has to handle a lot of tasks. Each of these tasks requires careful coding, especially in a generic engine, when almost no assumptions can be made.

All of these tasks have to be handled in a very efficient way, since the amount of checks that have to be made in every frame (Usually 1/25- 1/30 of a second) is enormous. For example, all the shots that have been fired have to be tracked and the game engine has to determine if they hit some sprite on the screen (or hit a wall and have to disappear).

Moreover, since this is an engine and not a single game it has to check what the exact rules are in this specific game, and apply them to the sprites (which also have some varying properties).

Also the devices on which the games run don't have a very advanced processor so efficiency is of the essence. This requires using sophisticated coding techniques and careful analysis of all the possible situations to know when to check some conditions every time, and when to check them only at a certain point of time. This also means using CPU-cycle saving techniques such as binary operators (shift left instead of multiply by 2), exiting conditioned loops as fast as possible, shortening the function calling stack etc.

As mobile devices also have limited storage space, all the code of each of the components must be compressed to a very small code base. To do that several techniques were used including intense code optimization, maximum object reuse, class consolidation (to avoid the “big” overhead that a separate class uses) and obfuscation (renaming all class/variants names to the shortest possible option—this is done by an automatic tool). Also the game files themselves are compressed to reduce the size they occupy on the phone.

The client also includes a Game Management System (GMS) that allows the user to connect to the download server and view a game catalog, download new games, and remove old ones. This actually enables the user to handle all of his games from a single interface. The GMS is necessary because the client application can only operate on data that it has access to, and in the J2ME security model each application (midlet) has access only to data it saved. Note that in the context of the present invention a midlet is any mobile application, not necessarily limited to an applet for J2ME, and likewise the term applet includes midlets and is not limited to Java applets.

This is why the whole process of downloading the game files needs to be done from within the application, and the game files have to be saved in the special reserved storage (called Record Management System or RMS). The RMS is normally used to store application data such as settings, records of data, high-scores etc. Here it is used in another way: to store the entire game.

To do this requires serialization classes that do not exist in J2ME. Serialization is actually taking a complex object and converting it into a flat stream (which can be transferred or saved). Since the game files contain complex objects of many types (graphics, sounds, integers, strings etc.) some kind of serialization mechanism is needed for transferring the file from the server to the client. While Java itself supports serialization, J2ME does not. So this part of the code has to be written for each and every object that the engine uses.

In a preferred embodiment, the server is written in Java and runs on any J2EE (Java 2, Enterprise Edition) container (tested on Tomcat and Resin on Windows and Linux respectively). The server includes two major elements: a download and distribution server and a game editor.

The download and distribution server serves as a delivery platform. This server receives requests from various devices and has to send them the relevant content. The download server is also responsible for sending the client the games catalog and letting the user browse and retrieve information about the different available games.

The download server detects the device that contacts it, and delivers the correct game file. This is a complex task because on the one hand it has to adapt to low end devices, which means giving up some content, but on the other hand game playability must be retained, so the consumer won't be disappointed in the end product. This involves a very delicate process of fine-tuning and finding ways to supply alternative content when the original content is not supported. A few examples of this are:
Decreasing the number of colors in the images without a significant drop in quality.
Resizing images when possible.
Substituting rich graphical backgrounds with a simple background (gradient).
Transcoding sounds and videos to supported formats.
Dropping frames of characters (but still retaining relatively smooth animation).
As a last resort: omitting optional elements (Game poster screens, intros etc.).

A database may hold several versions of each game file, each one adapted to a certain device (or a series of devices), or may hold several different packages, each including a different code layer. The game files are made in the final step of the editing process after the game designer is satisfied with his/her game. Although the game files could also be created in real time upon request, as each one occupies a small amount of storage space (in PC terms) it is advantageous to pre-generate them to optimize the response time upon receiving a request.

The download server is also responsible for sending billing notifications to the billing server of the operator. This may be done by issuing standard CDRs, or by billing servers of different operators.

Another feature that the download server supports is the distribution of games throughout a community. The server holds permission information for the different game files. For example when a user creates a game, it is accessible only to him. But if and when he invites his friends to download the game, the permission system automatically allows these users to access the game as well.

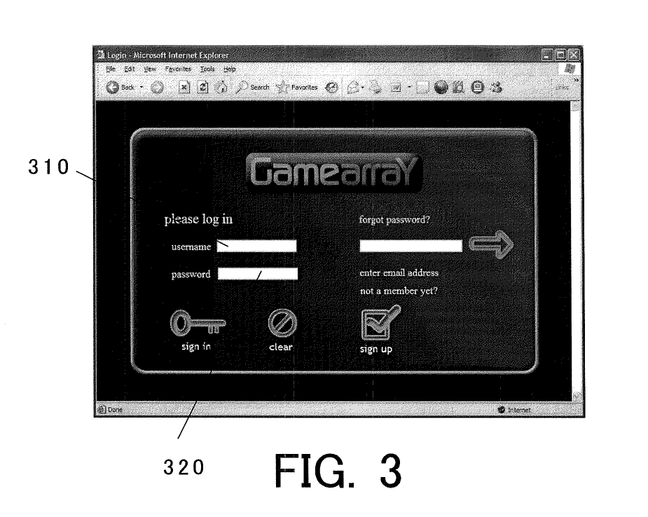

The login screen is shown in FIG. 3. The user has to input his name 310 and his password 320. Note that in some implementations, the user's credentials will be forwarded from another web site, so if the user has already logged in, this screen will be skipped. Also, it may be possible that even if the user is not logged in, he may be logged in through a login window on another site, thus rendering this screen irrelevant.

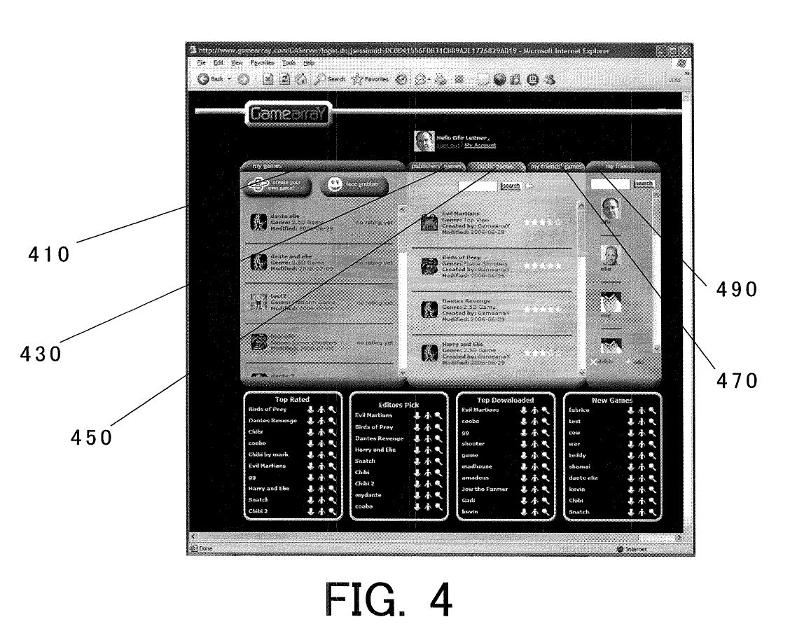

In a preferred embodiment, users are allowed to create their own games and share them with their friends, or with an entire community. In order to support these features, a full-blown community site is provided. The interface to the community pages is as shown in FIG. 4.

As can be seen from FIG. 4, the user can:
See a list of his games 410 and Edit/Delete them, or create a new one.
See games that were created by other parties such as:
Publisher games 430—Games made by professional publishers.
Public games 450—Games made by others and shared by all.
My Friends' Games 470—Games made by this users' friends.

For each of these the user can either download or edit the games.
See the list of his friends 490 with some basic details, and manage this list.

Other pages may be added for other purposes. For example:
Managing the friends/groups list (Adding/Removing/Inviting etc.).
Sharing games with other users/groups/entire community.
Viewing games listings (Most popular, Best games, Top games in category).
Rating games/users.
Sending games to friends from the site (via SMS or passively via catalog).
Messaging pages, forums, personal pages or chat pages

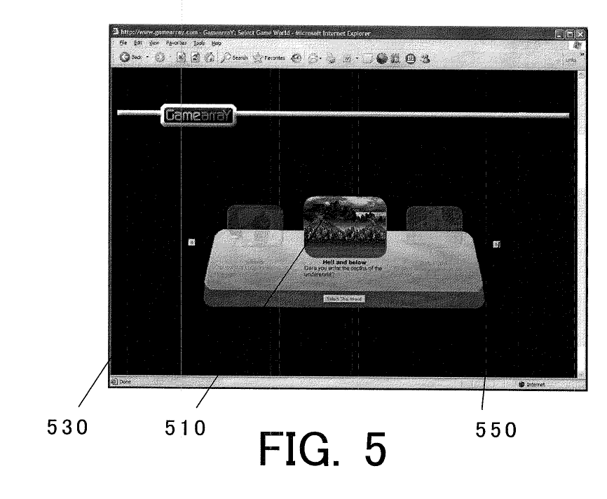

When the user chooses to create a new game, the screen shown in FIG. 5 appears. This screen allows the user to select a “Game World”, which is basically a template for the game that he is about to create. The user selects his desired game world 510 using the arrows 530, 550 at the sides, and once it is selected, he is transferred to the game editor. The game world selector is preferably a Flash component that can be customized.

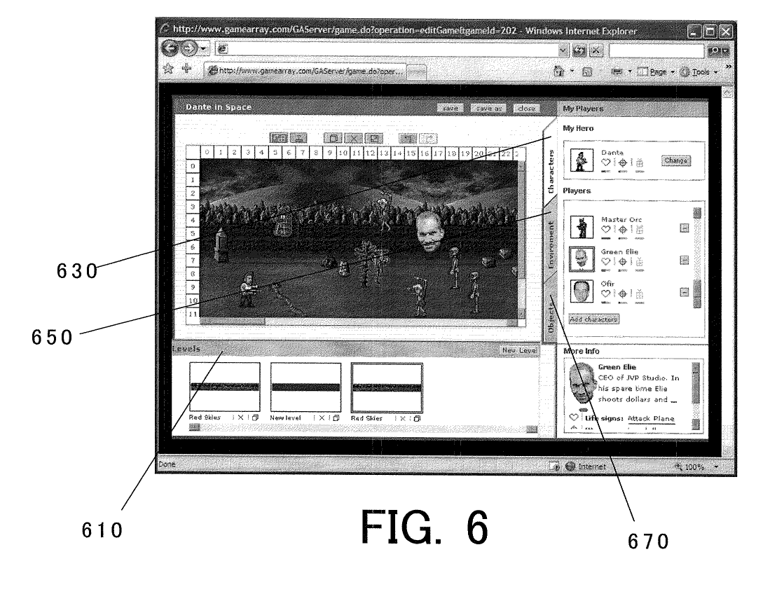

After the user has selected the game world, the game editor appears, as shown in FIG. 6. Levels 610 are shown on the left, and characters 630, environment 650 and objects 670 on the right. This is a powerful Java applet that allows the user to create multiple levels using different backgrounds, players and items. This applet may be customized, for example by changing the color scheme, localization etc.

The game editor allows both users and game designers to rapidly develop games for the platform. No programming skills are needed. The editor has two different modes: Personal for ordinary users who use it to customize games from their homes, and Professional for design houses and content owners that can use it to create complicated games.

The challenges faced when building the game editor include:
Simplicity of editing vs. Complexity of product—The editor has to be simple enough to be used even by ordinary users with no background in game design. This is a great challenge since it requires complex processes to be simplified into a user friendly interface.
Object relationships—The editor has to connect seamlessly between different types of objects. These objects include characters, weapons, items, life-signs, sounds, backgrounds etc. The complication involved in this is that to make a flexible system the editor must support complex and recursive interrelations between the objects. For example, a character can hold a limitless amount of weapons and items. An item can also be a type of a weapon, and a weapon can actually contain another weapon within it (for example a grenade is implemented by defining a harmless weapon that after a few seconds explodes into a deadly weapon—the blast).
Editor features adaptability—In order to customize the editor for different customers with different needs, a general framework has to be developed to support quick changes of the editor features. For example one customer might want his customers to be able to change only simple things, while the other might want to give all users the full available editing power (or of course anything in between). This kind of custom tailoring can be made only if the editor is built in a modular way that allows “editing” of the editor itself. The foundations for such infrastructure have been laid, but there is a huge amount of work to do it to get it into the desired status.
Standardization and code reuse—The enormous amount of different objects and the dozens of properties used to define a single game requires the creation of many screens that allow editing of these properties. The problem is that building specific code to support the editing of each type of object can make the code non-scalable. This is why a special MVC model was created. This model supports the common needs of all objects, but still allows unique manipulation in special cases. The model consists of a servlet that accepts the requests (Controller), then loads the relevant object (Model) and displays its current properties and the controls that allow the user to change it (View).
Portability—The server in this example was built so it can be run under any J2EE server and under any OS, which is very important since different customers might have different OS/Servers in their organizations. This was done by following the J2EE specifications and not using any server-specific code. The server was tested on Tomcat in Windows and on Resin in Linux.

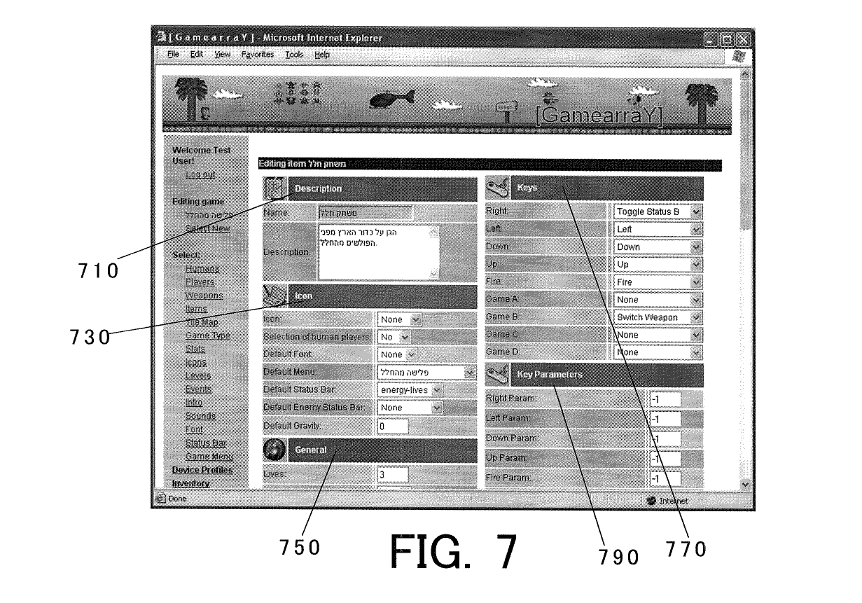

Most of the objects can be edited using the HTML generated pages of the game editor. As can be seen in the screenshot of FIG. 7, an object is composed of several properties organized in a property sets, i.e. Description 710, Icon 730, General 750, Keys 770 and Key Parameters 790.

The Game Type object is the object that defines the game genre and the default rules of the game. Ideally this object would determine only properties that are global for a certain game genre (Platform/Arcade etc.). However, in the example this object includes also properties that should be changed for each game (like icon, menu, font etc.). Each game has one (and one only) Game Type object. Among other things Game Type determines key mapping and key sounds.
Defaults (may show in editor as “Icon”)—This set of properties determines the default objects to use in this game type. These serve only as defaults and can be changed for each individual game, or in an alternative embodiment one must create a separate game type object. The properties are:
Icon—The icon of the game showed in catalog (can be none).
Selection of human players—Determines the behavior when more than one human player exists in a certain level. If set to No, all players will be shown, and the user will be able to switch between them with a defined key. If set to Yes, a selection screen will appear in the beginning of the game, telling the user to select a specific player to play with.
Default font—The default font to use in the game. None=System font.
Default Menu—The menu object to use. None=default (blank poster).
Default Status Bar—The status bar to use for this type of games.
Default Enemy Status Bar—Same, but for enemy player.
Default Gravity—The default gravity for levels created.
General—Defines these general properties:
Lives—Number of lives for the human player.
Kill Restart—If set to Yes, when the human player is killed the level restarts. If set to No, the player just reappears and can continue the level from the same spot. When multiple human players are present this decision point is reached only when all of them are dead.
Retain Player Data—
Menu Sound—The sound played when the game menu appears.
Game Over Sound—The sound played when the game is over.
Strike Sound—The sound played when the human player is killed.
Dead Interval—The number of time “ticks” before the sprite of a dead player vanishes.
Dead's Inventory—Determines what happens to items that a dead player carried. Possible values are:
   No—Items are all gone.
   Corpse—A player that walks over the dead player's corpse before it disappears gets all of his items.
   Leftovers—All of the dead player's items is scattered around.
Dead's Inv. %—The chance that the dead player inventory will be indeed given when “Dead's inventory” is set to Corpse/Leftovers.
Flying Score—When getting points, the score will “fly” for a period of time “ticks” defined in this property (−1=Don't use flying scores).
Fire Collisions—Determines whether fire cancel each other out.
Sprites Blocks—Determines whether sprites “block” each other. This has some effects on performance, but should be turned on when it is not desirable that a player will be able to walk on another one (for example in top-view games). Possible values are:
   No—No sprite blocking, one player can go over another one.
   Players—Only players block each other.
   Items—Only items block players.
   Both—Both players and items block.
Self Shooting—Defines whether the shots of a player can hurt himself, or his “friends”:
   No—A player is not affected from his own shots, but can be affected from shots of every other player (human and computer).
   Yes—Each player is affected from any fire shot. Including self-fire and friendly-fire.
   Teams—A human player can shoot only enemies and vice versa.
Enemies take items—If set to Yes, enemies will take items.
Edges explode fire—If set to No, shots that exceeds the game's canvas will disappear, If set to Yes they will explode (if their “Blast Weapon” property is set to trigger some kind of blast).
Game Type—This selects between 2D and 2.5D:
   2D—A regular 2D game (Platform/Space shooters/Top-view etc.)
   2.5D—A 2.5D (i.e. Golden Axe, Double Dragon). This affects a lot of the calculations of sprites collisions, sprites display order and more.
Max Fall—The maximum number of tiles a player can fall without dying.
Human Dead Interval—The number of time “ticks” to wait after the human player dies before restarting the level or bringing a new player.
Enemy SB—Defines the enemy type that has a status bar. Not every enemy has a status bar, but only important ones (bosses). The status bar will appear as this enemy is visible on screen.
Default Level—This set defines default values for each level:
Start Sound—The sound played when the level starts.
End Sound—The sound played when the level ends.
Start Effect—The special effect to use when showing the level (fly in, dissolve etc.)
End Effect—The special effect to use when exiting the level.
Time—The time limit for the level. If this time passes, player loses one life. −1 means no time limit.
Time Threshold—Below that threshold there is no time bonus.
Time Bonus—The amount of bonus points per second.
X Threshold—The number of pixels before the horizontal edge of the screen that the player can approach without horizontal scrolling.
Y Threshold—The number of pixels before the vertical edge of the screen that the player can approach without vertical scrolling.
ShiftX—The number of pixels to automatically scroll the screen horizontally in each time tick. Possible values:
   0—No automatic scrolling.
   Positive value—Scroll to the left.
   Negative value—Scroll to the right.
ShiftY—The number of pixels to automatically scroll the screen vertically in each time tick. Possible values:
   0—No automatic scrolling.
   Positive value—Scroll downwards (Space Shooters).
   Negative value—Scroll upwards.
Init X—The horizontal tile that will be in the left corner of the screen.
Init Y—The vertical tile that will be in the upper corner of the screen.
Keys—This set of properties is used to map the keys to the different actions. The “properties” here are the keys themselves, which are:
Right, Left, Down, Up—Self explanatory.
Fire—The fire button of the device (Can differ for each device).
Game A/B/C/D—The action buttons (Can differ for each device).

Each and every key can be mapped to one of the following actions:
Right, Left, Down—Self explanatory.
Up—When gravity is 0, goes up. When it's not, jumps (or climb ladder).
Fire—Fire the current weapon.
Use Item—Use the current item.
Take Item—Take the item the player is standing next to (explicit take).
Sw.Item—Switch the current item.
Sw.Weapon—Switch the current weapon.
Sw.Player—Switch to another human player (when multiple are present).
Rotate.Rt—Rotate to the right (basically switches to the next direction).
Rotate.Lt—Rotate to the left (basically switches to the previous direction).
Forward—Moves forward in the current direction.
Backward—Moves backward (according to the current direction).
Load Weapon—Loads a clip to the current weapon.
Fire Weapon X—Fires the weapon of weapon type X (Defined in parameter).
Change Mode—Changes the player's mode to the mode in parameter.
Use Item X—Uses the item of item type X (Defined in parameter).
Jump—Jump (Height defined in parameter).
Inc Speed—Increases the current speed (factor defined in parameter).
Dec Speed—Decreases the current speed (factor defined in param).
Accelerate—Increases the current acceleration (factor defined in param).
Decelerate—Decreases the current acceleration (factor defined in param).
Toggle S.Bar—Shows/Hides the status bar.
Enter Vehicle—Unimplemented yet.
DelayT,DelayM—Used for debugging.
End Game—Ends current game.
Key Parameters—A parameter that complements the key mapping above. The effects of this parameter were explained in the Keys property set.
Key Sounds—Defines the sounds that will play when the different keys are stroked. Note that assigning sounds to keys and not to the sprites themselves can be very useful. For example we might want a sound effect for our player when he jumps, but the same player can be selected in another game as an enemy and appear 10 times, and when every one of these enemies jump we would here the sound effect . . .
Goals—This property set defines the goal of the game for each level. Different goals may be assigned to different levels.
Kill All—If set to Yes the goal is to kill all enemies.
Kill Enemy—If specified, the goal is to kill this enemy.
Obtain Item—If specified, the goal is to obtain this item.
Reach Location—If set to Yes, the goal is to reach a certain area.
X1—The left border of the area the player has to reach (in tiles). This property also accepts the following special values:
   −1—Reach the right side of the “world”.
   −2—Reach the left side of the “world”.
   −3—Reach the lower side of the “world”.
   −4—Reach the upper side of the “world”.
X2—The right border of the area the player has to reach (in tiles).
Y1—The upper border of the area the player has to reach (in tiles).
Y2—The lower border of the area the player has to reach (in tiles).

Note: If several goals are mentioned, they all need to be achieved.

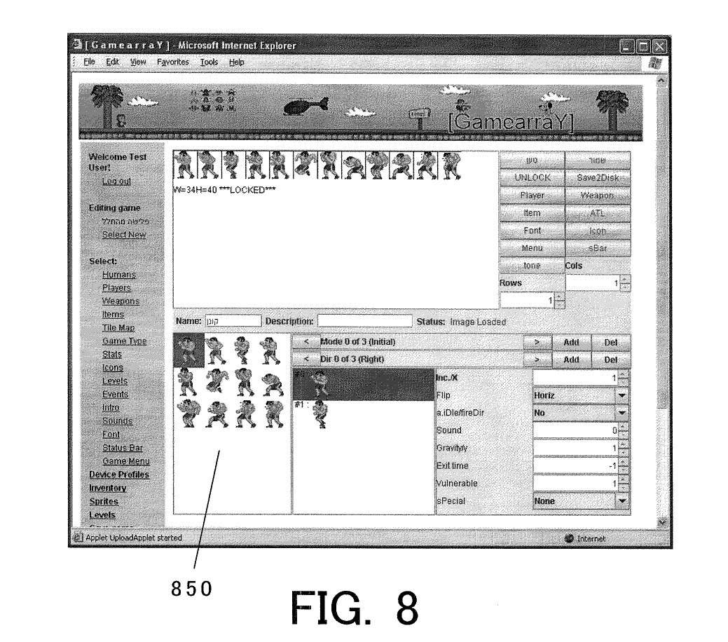

A sprite is a super-object that is never used on its own, but extended to more elaborate objects such as players, weapons and items. The sprite object contains all the properties that affect the sprite behavior in the game. This includes that sprite's visual representation, sounds and relationship with the physical world (Gravity, vulnerability etc.). Sprites are rather complex objects, and they are edited using a special applet shown in FIG. 8. This applet allows more complex editing than is possible in the regular HTML based editor pages.

A sprite is first created by using a graphics file that contains all the possible ways in which the sprite will be visually presented. Usually this file includes many frames of the sprite with each frame showing the sprite in a certain pose. For example, the sprite shown in FIG. 8 inside the editing applet has 12 frames, as for example seen at 850, which originate from a flat graphics file that contains all 12. Within a sprite object, all the frames have a constant size. For example, the frames shown in FIG. 8 are 34 pixels in width and 40 pixels in height (34×40). This was achieved by splitting the 408×40 file to 12 different 34×40 frames.

Each sprite has one or more modes (up to 128 in this example). A mode is a certain state of the sprite, which differs from other modes in its visual representation and/or other properties. For example a sprite can have the following modes: Walking, Dead, Paralyzed, Running etc.

Modes are numbered, starting with 0. The only fixed modes are:

0—Initial. The sprite's starting mode (Usually walking).

1—Dead. When a player reaches this state, the engine knows its dead and acts upon it.

Although these are the only two modes that have a special treatment within the engine environment, it is best to determine other “well-known” modes, in order to allow all players/weapons/items to have a logical effect in all games. The only well known-mode defined so far is:

2—Hurt/damaged. Used for players when they are shot.

Each mode has several directions (Dirs). The default number of directions is 4, numbered 0-3:

0—Right.

1—Left.

2—Down.

3—Up.

A certain mode of a sprite can theoretically have only one direction, but that's not normally used. Also it should be noted that more complex sprites can have more than 4 directions (diagonals, up to 128 different directions), in which case usually the directions' numbers are not significant.

As mentioned above, each sprite has several modes and each mode has several directions. The combination of a mode and a direction is an “atomic” unit of the sprite, which contains the properties and frame sequence for this mode-direction combo.

The frames sequence is a fairly simple concept: From all of the defined frames that the sprite uses, each mode-dir combo uses a few. For example in the Initial(0)-Right(0) combo we may assign 2 frames in which the sprite is seen walking to the right. A frames sequence can also include the same frame multiple times (This can be used for several reasons including delays—showing a certain frame for a longer time than the others). It is also possible to use the “empty frame” to create a blinking effect.

Aside from the frame assignment each mode-dir combo has the following properties:
Inc./X—This is a double property used for:
Inc (For standard 4-directions sprites)—Defines how many pixels the sprite will move for a single movement. The movement itself will be done according to the direction.
X (For complex sprites)—Defines how many pixels this sprite will move horizontally for a single movement in this mode-dir.
Flip—Defines how to flip all frames in this mode-dir. Possible values are:
None—Keep frames as they are.
Vert—Flip frames vertically.
Horiz—Flip frames horizontally.
Rot180—Rotate 180 degrees.
Rot270m—Rotate 270 degrees and mirror.
Rot90—Rotate 90 degrees.
Rot270—Rotate 270 degrees.
Rot90m—Rotate 90 degrees and mirror.

Note: Rotations of 270/90 may not be supported on all devices.
a.iDle/fireDir—A double property used for:
a.iDle (For players)—If this sprite is a player, this property determines which mode to go into when this player is idle (usually used to show the main character yawning or being impatient if the user doesn't move him for a while). Note that this can be defined in the mode-dir level, since if the player is in a regular mode we might want to go to an idle mode, but if the player is in a dead/paralyzed mode we don't want to go to an idle mode if he doesn't move. The value of this property is the “idle” mode number. Special values are:
   No (−1)—Don't go into any idle mode.
   Yes (−2)—This mode is an idle mode in itself.
fireDir (For weapons)—If this sprite is a weapon, this property determines the direction of weapon fires. Note that each weapon has also directions of its own, but this property is used to define whether the sprite's current direction should affect the weapon dir. For example, the direction of fire for a top-view character changes according to where he goes. However, the direction of fire for a spaceship in a space shooter game, always stays upwards, no matter if it moves left and right. Possible values are 0-3 (Right/Left/Down/Up).
Sound—Determines the sound effect which is used when the sprite is moving in this mode-dir. This accepts a numeric value, which points to the sound table of the specific game or the generic client sound table. Alternatively, this could be indicated in the editing applet by the sound sample name. Possible values are:
0—no sound.
Positive integer—A sound from this game's sounds table.
Negative integer—A sound from the client's sounds table (WAV only).
Gravity/y—A double property used for:
Gravity (For standard 4-directions sprites)—Determines the gravity factor for this sprite in the current mode-dir. Note that a sprite can be affected by gravity in certain modes (walking) and not affected in others (flying). Possible values are:
   0—Not affected by gravity.
   1—Normal gravity effect.

Other positive integers—Stronger gravity effect. Negative gravity (“falling” upward) could optionally be represented by a negative integer.
Y (For complex sprites)—Defines how many pixels this sprite will move vertically for a single movement in this mode-dir (This replaces the gravity property since it is not relevant in complex sprites which always operate in top-view worlds, which are inherently without a gravity property).
Exit time—Defines the number of frames before this mode “returns”. This allows defining a mode that is not permanent such as taking an invulnerability potion, so that the sprite can get out of that mode and return to the former one. Another common use is defining modes of firing a certain weapon: When we fire the weapon the sprite has a different animation set, and then returns to the previous mode. Possible values are:
−1—No “exit time”—this is a constant mode (i.e. walking)
Positive integer—The number of frames before this mode exits.
Vulnerable—Determines the vulnerability of this sprite (applicable to players). This is used in two ways:
General vulnerability (from weapons, items etc.)—If the value of this property is −1, this player is invulnerable. Any other value—vulnerable.

Players' collisions—When two players collide, a comparison is made between the values of this exact property in the relevant direction. The player with the highest value “wins” and inflicts its collision effects on the other. If the value is equal—no one gets hurt. For example, to define a Super Mario like behavior: If Mario jumps on a turtle, then the Vulnerable property of Mario in the current mode and the “down” direction (which will be 2) is compared with the turtle's Vulnerable property in his current mode in the “up” direction (which will be 1). Mario wins. But if Mario goes to the turtle from the right, then his Walking(0)-Right(0) Vulnerable property will be 0, and the turtle's Walking(0)-Left(1) Vulnerable property will be 1—so turtle wins.
sPecial—This property is used to define additional special properties:
No Clipping—Sprite can walk through walls.
Invisible—Sprite is invisible. If an enemy sprite is invisible, the user will not be able to see it. If the human player of the game is invisible, the user will see it, but the enemies will treat it as they don't see it at all.
Dead—This indicated that this mode is also a “dead” mode, In addition to the well-known dead mode (1). This can be useful to define several kinds of deaths.

In this preferred embodiment, all properties have a minimum value of −128 and a maximum value of 127 (Unless further restricted by the property definition itself).

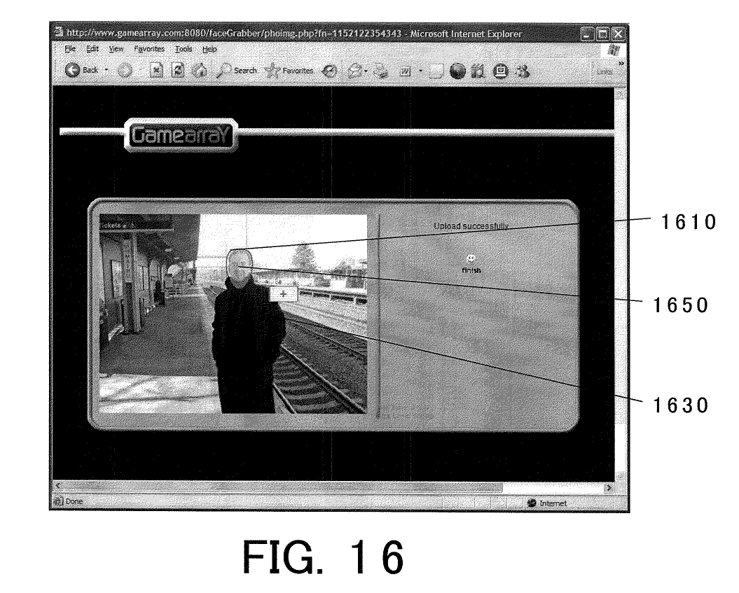

The game editor also has the ability to “grab” a face from a picture and then implant it as a game element, as shown in FIG. 16. This is done by placing an elliptic mask 1610 on the image 1630, matching the face area 1650. The mask 1610 can be enlarged or reduced, and can rotate in all directions. More features may be added such as:
Applying standard graphics effects.
Adding funny elements to the face (moustache, horns, crazy-eyes, beard etc.).
Face animation (i.e. dropping the jaw in one frame, and closing in the other).

Before explaining the player, weapon and item objects one must understand the concept of stats. To do that we need to define the following terms:
Effect Type—Each game can have its own set of effect types. An effect type is an abstract game concept that players/weapons/items can have effects upon. Examples for effect types are: energy, fuel, food, diamonds, coins etc.
Effect—An effect is a simple reaction that a certain object has on a player. A single effect can affect only one effect type (but certain objects can have several effects). For example certain weapons can have the effect of reducing 3 to 5 points of energy to the player they hit.
Stat—A stat defines the behavior that a player has for a certain effect type. For example, a player can have a stat that defines that he has 60 points of energy out of a possible 100. When his energy decreases he goes into mode 2 (hurt), and when the energy goes below 0 he goes into mode 1 (dead). A player can have limitless stats defining his behavior for different effect types.

It is important to understand that while player, weapons and items can inflict effects in regards to all effect types, only players are the ones who can actually have stats and thus are also affected by these effects.

The most important property of a stat object is which effect type it refers to. This is determined by the “effect type” property. After selecting this property all the other property relate only to the specific effect type selected.

Since the terms stat/effect/effect type can be confusing, it will be assumed that a certain effect type (energy) was selected when explaining the other properties:
Initial Val—The initial value of energy.
Min Value—The minimum value of energy.
Max Value—The maximum value of energy.
Dec Mode—The mode that the player who has this stat goes into when his energy decreases. −1 means none (continue with current mode like nothing happened).
Inc Mode—The mode that the player who has this stat goes into when his energy increases. −1 means none (continue with current mode like nothing happened).
Low Threshold—Defines a lower threshold. If the energy goes below this number, the player will go into the mode entered in “Low Mode”.
Low Mode—The mode that the player who has this stat goes into when his energy falls below the threshold defined in “Low Threshold”. −1 means none (continue with current mode like nothing happened).
High Threshold—Defines an upper threshold. If the energy goes beyond this number, the player will go into the mode entered in “High Mode”.
Low Mode—The mode that the player who has this stat goes into when his energy exceeds the threshold defined in “High Threshold”. −1 means none (continue with current mode like nothing happened).
Time Ticks—Defines a certain interval (we'll call it X). Each X time units the effect that was entered in “Time Effect” will be inflicted upon the energy of the player who has this stat. −1 means no interval.
Time Effect—The number of energy points that will be increased/decreased. Note that on this property −1 doesn't mean nothing, it means that a single point of energy will be decreased whenever the interval defined in “Time Ticks” arrive. The way to neutralize this mechanism is by entering −1 in “Time Ticks”.

In addition to defining the different modes that the player goes into in different situations (Dec/Inc/Low/High Mode), there is also a way to define that in these cases the player will turn into another player. This can be done in the editor by choosing in the Misc. tab the appropriate case (dec/inc/low/high) and moving it into “another player”. This is useful when the new “mode” of the player requires using a set of frames that is not in the same size as all of the player's frames. For example going from Regular Mario to Super Mario.

Another property of a stat object that should be mentioned is “icon”. This property just determines the icon that will be used in the status bar to show the state of the player's energy (or other effect types).

It is important to understand that there is no real difference between a human controlled player and a computer controlled player (AKA: Enemy). Enemies have the same capabilities that human players have and vice versa. This is mainly due to the fact that a “hero” in one game can be selected as the “enemy” in another. The positive side effect of this is that enemies can be very sophisticated.

A player object is built upon a sprite object. This means that it has all the properties of a sprite object as defined above, and in addition it also has the following properties (Classified by the categories on the web-editor):
Icons
Lives Icon—Determines the icon that will be used when showing how many lives this player has left (Only relevant to a human player, but defined for all players in case they are selected as the human player).
Player Icon—Defines the icon this player will have when selecting him. This applies to games where before the start of the game the user can select with which player he wants to play. If this property is undefined, the first frame of the player will be displayed.
General—Defines the following general properties:
Maximum Weight—Defines the maximum weight this player can carry. This relates to the weights of items and weapons. A value of −1 means unlimited.
Score Worth—The score received for killing this player (when he is an enemy). This can also be a negative value, meaning killing this “enemy” is a mistake (for example: a fairy).
Strategy—This set of properties defines the AI of the player (When he acts as an enemy):
Act When—Defines when this player will act. Possible values are:
   Always—Always (even when not seen on screen).
   When Visible—Only when seen on the screen.
   Always and When Shot—Always and when shot—follow the hero
   When Visible and When Shot—Same as above but when visible.
   As a group—This groups this players with other players that use the same “Act When” strategy (for example: space invaders).
Delay—This determines the speed of movement for this player. The higher this number is, the slower it will be.
Move Pattern—Determines how this player moves. Possible values are:
   Don't Move—This enemy doesn't move (i.e. A canon turret).
   Simple Dir—Moves straight in a certain direction.
   Follow—Follows the human player.
   Patrol—Patrols in a certain region.
   Escape—Escapes from the human player.
   Square Patrol—Patrols in a square pattern.
   Space Invaders—A specialized strategy for space invaders.
Movement parameter—This parameter affects the move pattern for certain patterns (non-listed patterns are not affected by it):
   Simple Dir—Determines the direction (Regular 0-3 dir values).
   Patrol—The number of tiles this player will span in its patrol. A positive value means a horizontal patrol and a negative value means a vertical patrol.
   Square Patrol—The number of tiles the square patrol includes.
Fire Pattern—Determines the fire strategy of this enemy:
   Dont Fire—Doesn't fire at all.
   Intervals—Shoots at certain time intervals.
   Random—Shoots on random time intervals.
   Clear Shot—Shoots only when the human player is in the range of the weapon that this enemy currently carries.
Fire Parameter—Affects the fire pattern for certain patterns (Non-listed patterns are not affected by it):
   Intervals—The time units between each shot.
   Random—The probability (in %) that this player will shoot in each time unit. (100=shoots all the time without stopping).

In addition to these properties, a player also has a vector of each of the following:
Effects (Collision)—Each player can have zero or more effects that he inflicts upon collision with another player. These will be inflicted only if he “wins” in the collision. Each effect is composed of these three properties:
Effect Type—The effect type that this effect relates to (energy/food/fuel)
Min—The minimum value that can be inflicted.
Max—The maximum value that can be inflicted.

Note: The actual effect will be a random value between Min and Max.
Weapons—Each player can have zero or more weapons in his possession. It is also possible to define how many clips this player has for each weapon (if applicable). For a human player different weapons may be shot with different buttons, or can be alternated using a defined key. Computer controlled players currently use only the first weapon in their possession.
Items—Each player can have zero or more items in his possession. It is also possible to define how many units this player has of each item (if applicable).
Stats—Each player can have zero or more stats (but usually have at least one). The stats as defined above define the behavior of this player in regard to effects inflicted upon him by other objects to various effect types (energy etc.).

A weapon object is also built upon a sprite object. It should be clarified that the sprite of a weapon object is not a visual representation of the weapon itself, but of the bullets that it fires.

The visual representation of the weapon itself can be defined as an icon, so it can appear in the status bar. The definable icons are:
Weapon Icon—An icon representing the weapon itself.
Clip Icon—An icon representing one clip.
Bullet Icon—An icon representing one bullet (Useful for special missiles which are usually limited in number, but don't come in clips).

Besides the properties inherited from the sprite object the additional properties that the weapon object defines are:
Clip Size—The number of bullets each clip of this weapon has.
Speed—The speed of movement (This is multiplied by the Inc property of sprite).
Min. Range—The minimum range (in tiles) that this weapon can reach.
Max. Range—The maximum range (in tiles) that this weapon can reach. The actual range for each shot will be a random value between the min and max range.
Weapon Weight—The weight this weapon weighs.
Clip Weight—The weight of a full clip of this weapon.
Accuracy (%)—The probability that the weapon will actually hit a player.
Min. Hits—The minimum number of players that a single fire of this weapon can hit before disappearing.
Max. Hits—The maximum number of players that a single fire of this weapon can hit before disappearing. The actual value for each shot will be a random value between the Min and the Max hits.
Fire Sound—The sound played when firing the weapon.
Hit Sound—The sound played when a player is hit by this weapon.
Load Sound—The sound played when loading a clip.
Empty Clip Sound—The sound played when the current clip is empty.
TimeOut (Min)—The minimum time (in “ticks”) before a fire of this weapon disappears/explodes (depends on Blast Weapon).
TimeOut (Max)—The maximum time (in “ticks”) before a fire of this weapon disappears/explodes (depends on Blast Weapon). The actual value for each shot will be a random value between the Min and the Max timeout.
Blast Weapon—Defines the weapon that this weapon blasts into after the timeout. For example to define a grenade, two weapon are created: Weapon A which is harmless but moves and has a certain timeout and has Weapon B as its blast weapon. Weapon B is a harmful weapon that doesn't move but produces deadly blasts in several directions.
Mode Change—The mode that a player that is hit by this weapon goes into. This is a direct mechanism that can bypass mode changes through the stats.
Blasts Walls—Defines if this weapon can blast through walls and if so which types. The value here is the max tile number that this weapon can blast (so when designing a tile-set one should put the weakest tiles first and then the stronger ones). If set to −1 shots from this weapon disappear/explode upon wall impact.
Simultaneous Shots—The number of shots of this weapons that can be shot simultaneously (−1 means unlimited).

Aside from these properties each weapon has:
Effects—Each weapon has zero or more effects. These effects will inflict damage upon impact of the shot with a player. The structure of the effects is:
Effect Type—The effect type that this effect relates to (energy/food/fuel)
Min—The minimum value that can be inflicted.
Max—The maximum value that can be inflicted.

Note: The actual effect will be a random value between Min and Max.

Note 2: Even a weapon without effects can affect the character, for example by changing his mode (See “Change Mode” property in this section).
Directions—Each weapon can have several directions. The direction relate also to the direction of the player that shoots it so that a straight blast will go right when the player is facing right and left when he is facing left (And this behavior can be customized. Aside from the regular directions (Straight, Rear, Right, Left), the editor also suggests direction “packs” that are just shortcuts to add several directions at once:
Front spread—Shoots ahead and in the two surrounding diagonals.
Rear spread—Shoots to the rear and in the two surrounding diagonals.
Plus—Shoots in all straight directions (0/90/180/270 degrees).
X—Shoots in all diagonal directions (45/135/225/315 degrees).
Full Blast—A combination of Plus and X.
Customized—Allows the user to define X and Y values that determine the increments that the shot passes in each direction (For example if X=2 and Y=1 that means that the shot will advance 2 pixels to the right and 1 down in each time “tick”).

It should be noted that a weapon has no “independent existence”. It can either be held by a player, or be encapsulated inside an item (when drawing the screen in the level editor one cannot add a weapon but only players/items).

Not unlike the player and weapon objects, an item is also built upon a sprite object and inherits all its properties.
Weight—The weight of this item.
TTL—Time to live. The number of seconds before this item disappears.
Take Mode—The mode a player goes into when he takes this item (−1=None).
Preservable—Indicates whether this item can be taken and preserved, or taking it causes immediate use of the item.
Shoot Effect—Defines what happens when this item is shot. Options are:
None—Nothing happens to it.
Disappears—Item disappears.
Explodes—Creates an explosion, which is a shot from “Weapon Type”.
One Time—Defines whether after using this item it is gone, or can be used multiple times. For example a health kit can be one time, but a “health fountain” can be used multiple times (And will also be non-preservable)
Is Weapon—If this is set to Yes, this item encapsulates a weapon.
Weapon Type—Can be used for multiple purposes:
If “Shoot Effect” set to “Explodes”—The weapon type for explosion.
If “Is Weapon” set to Yes—The type of weapon this item encapsulates
If “Is Weapon” set to No—The item may be clips for this weapon.
Clips—The number of clips from the weapon type (0=None).
Portal X—If this is not set to −1 then this item is a portal, meaning that colliding with it results in transporting the player to a different location. This property defines the horizontal location he will be sent to (in tiles).
Portal Y—The vertical location/tile that the player will be sent to.
Score Worth—The score increase/decrease for taking this item.
Requires Item—Defines a “key” item that without it one cannot take/use this item. This can be used in conjunction with the Portal properties to create a locked door.
Take Sound—The sound played when this item is taken.
Use Sound—The sound played when this item is used.
Trigger Event—The event number that this item triggers when used (−1=None).
Item ChangeMode—The mode the player goes into when taking the item. This can be used to animate the player taking it.
Use Mode—The mode the player goes into when using the item.
Needs Explicit Take—If this is set to Yes then in order for the player to take it, a special key has to be pressed. This can be used to simulate switches.

On top of these properties each item can have zero or more effect (exactly like weapons). Also an item can have an Orbit that allows it to move before taken. This is defined the same way that a player's strategy is defined, but without a fire pattern.

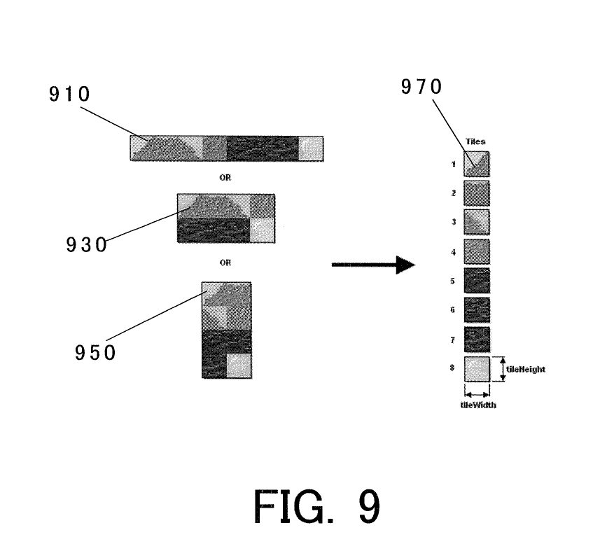

A tile map (or tile-set) is created by taking a flat graphics file and dividing it into “tiles”. This is done in a similar way that a graphics file for a sprite is divided into frames. For example any of the images 910, 930, 950 on the left side of FIG. 9 can be converted to the 8 tiles 970 shown on the right.

The reason for creating a tile-set is to enable an efficient mechanism for drawing the background of the game without having to save very large images. Without using tiles, if we wanted to create a background for a game that spanned over 1000×128 pixels we would have to save a very large image (or at least very large in mobile phone terms).

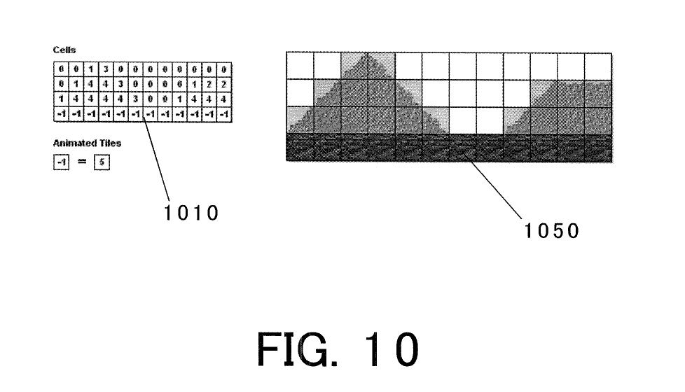

Using tiles, we can just draw the background from a few simple building blocks. The idea is to create a two-dimensional array 1010 that maps tile numbers into real graphics 1050, as shown in FIG. 10. This is a known technique in gaming. The images of FIG. 9 and FIG. 10 were, in fact, taken from Sun's J2ME API specifications.

Another advantage of using tiles is that we can define each tile to have its unique properties in terms of game play: A stone tile can block the player, a tile that is used for drawing a mountain is a background tile (a player can walk “through” it), certain tiles can be deadly, etc.

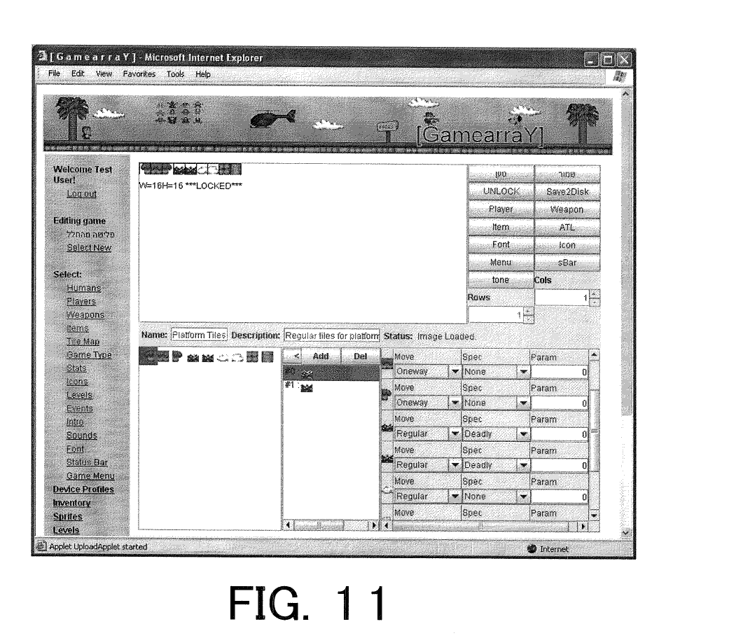

Creating a tile-set object begins with uploading a flat graphics file, and breaking it into tiles. The size of each tile in a specific tile-set is constant. The whole process is done with the editing applet, which is also used when creating sprites, but the interface changes once we identify the file as a basis for a tile-set. In the example shown in FIG. 11 we are creating a tile-set of 9 tiles, each sized at 16×16 pixels:

Besides static tiles, there is also an option to define animated tiles. Animated tiles are actually composed of a sequence of static tiles to create an animation effect. In the example above the two “sea” tiles can be sequenced and defined as a new tile. This creates a “wave” effect, so the sea looks like it's moving.

After dividing the image into tiles and defining animated tiles, each tile can be assigned with the following properties:
Move (Movement)—Determines how sprites can move when reaching such tile:
Regular—Sprites can walk “through” this tile.
Block—Sprites are blocked.
Ladder—Regular, but players can also move upwards with no gravity.
One Way—When coming from below—Regular, from above—Block.
Spec (Special)—Determines some special properties regarding this tile:
None—No special effect.
Deadly—Affects the player's energy.
Shootable—When shot by a “wall blasting” weapon turns to another tile.
Ch. Mode—Changes the mode of a player that “touches” that tile.
Trigger—Triggers a certain event.
Trigger Rt/Lt/Dn/Up—Same as trigger but only when from a certain dir.
Param (Parameter)—Relates to the special properties in these cases:
Deadly—The first effect type (usually energy) is increased/decreased.
Shootable—The tile turns into the tile num specified here (−1=disappear).
Ch. Mode—The player goes into the mode specified here.
Trigger—The event number that is triggered when this tile is “touched”
Trigger Rt/Lt/Dn/Up—Same as trigger.

As mentioned above, the tile-set allows us to create a background layer, which serves as a “game board” that the different sprites react to. This is called the main layer, but besides this layer, back and front layers are also supported:
Back Layer—A back layer is a background layer that appears “behind” the main layer or game board. This layer moves either with the main layer, or moves “slower” than the main layer. This creates a 3D illusion of far-away scenery. GamearraY supports a limitless number of back layers for each screen, which allows this effect to be enhanced by incorporating several layers each moving at its own pace.
Front Layer—A front layer is a background layer that appears “in-front of” the main layer. Very similar in concept to a back layer, each screen can have multiple front layers, but unlike back layers, the front layers usually move faster than the main layer (since they are “closer” to the user). Note that front layers will conceal all sprites since they are “closer”. When designing such a layer it should not be filled up with tiles. Instead, many areas should have no tiles, so the sprites can be seen.

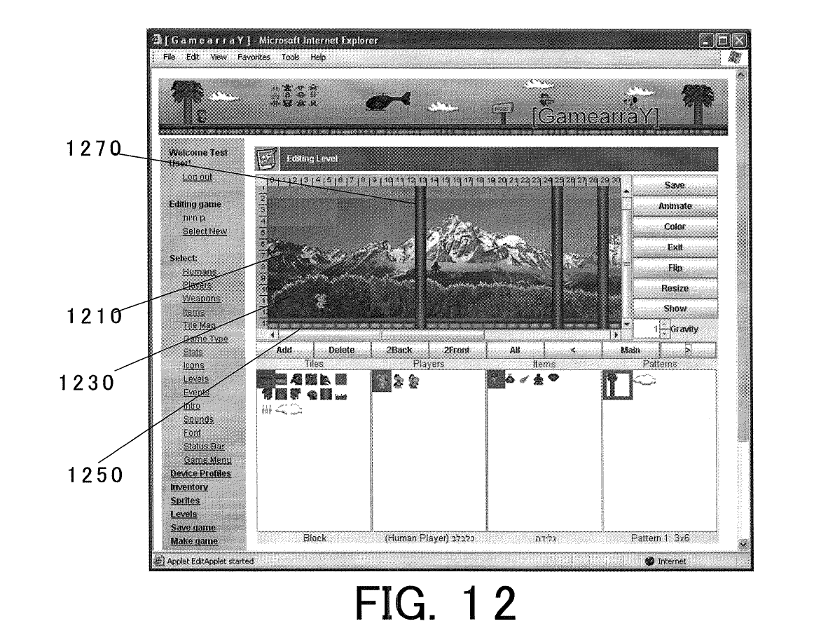

The definition of the type of the layer (main/back/front) is not done in the tile-set itself. Actually, one tile-set can serve as a main layer in one game, and as a back/front layer in another. The definition is done when editing a specific level in the level editor. In the example of FIG. 12 the game includes four layers:
Mountains 1210—This is the farthest back layer.
Bushes 1230—This is a “closer” back layer.
Floor 1250—This is the main layer.
Poles 1270—This is a front layer.

Notice that back/front layers have no meaning in terms of their tiles' properties. This is just disregarded by the engine. In the example of FIG. 12 the main layer has a floor that the sprites react with (i.e. they don't fall off the screen), but in the front layer there are poles that may be defined as blocks, but since they are not in the main layer they serve only as a graphical setting.

Each back/front layer has the following properties:
xFactor and xStep—Each xFactor pixels that the main layer moves horizontally, this layer will move xStep pixels.

Note: If xFactor is bigger than xStep the layer will move slower (back layer). If it is smaller, than the layer will move faster (front layer).
yFactor and yStep—Each yFactor pixels that the main layer moves vertically, this layer will move yStep pixels.

Note: If yFactor is bigger than yStep the layer will move slower (back layer). If it is smaller, than the layer will move faster (front layer).

As previously stated, all back/front layer properties are defined in the level editor when designing a specific layer. This is done by using the “Layers toolbar” which is located just below the editing canvas and above the different object boxes (appears only in Professional mode).

Here's a quick user guide for the buttons:
Add—Adds another layer. This opens a special window that lets the user select the tile-set to use for the layer, the map size (number of tiles horizontally and vertically), and the x/y factor/step values.
Delete—Deletes the current layer.
2Back—Moves the current layer one step back (a main layer becomes the “closest” back-layer, the first front layer becomes the main layer, others just move inside the back/front layers hierarchy).
2Front—Moves the current layer one step forward (a main layer becomes the first front-layer, the “closest” back layer becomes the main layer, others just move inside the back/front layers hierarchy).
All/UpTo/Current—This button (text switches upon activation) determines the viewing mode for editing. Options are:
All—All layers are shown.
UpTo—All layers up to the current layer are shown.
Current—Only current layer shows.
<and>—Selects the current Layer.

Main/Back #/Front #—The button between the <and> buttons shows the type and order of the current layer. Pressing this button also opens a window that allows changing the x/y factor/step.

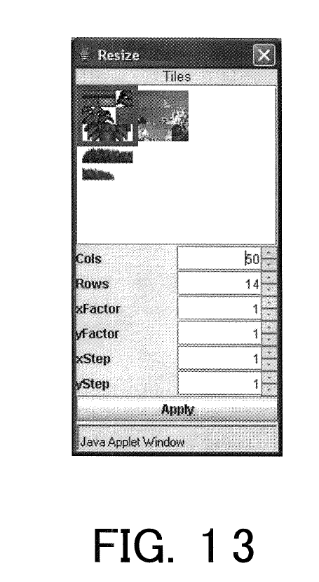

FIG. 13 illustrates the window shown when pressing “Add”.

Note that each layer has a single tile-set but different layers can have different tile sets with different size tiles.

An event is an abstract object that defines some sort of happening on the screen, triggered by some sort of situation.

The properties of an event object are:
X—Defines the horizontal tile location in which the event will occur. Special values are:
−1—Choose randomly
−2—Choose randomly, but on the visible portion of the screen only.
Y—Defines the vertical tile location in which the event will occur. Special values are the same as in X.
INTERVAL—Defines the time interval between event occurrences:
0—This event never happens spontaneously but only as a reaction to some kind of a trigger.
Positive Integer—This event will occur each INTERVAL time ticks.
Negative Integer—This event will occur randomly. The absolute value (positive) of this property is actually the probability (in %) that it will happen (computed each time tick).
Type—Defines the type of event. Possible values are:
Enemy—Puts a certain enemy on screen.
Item—Puts a certain item on screen.
Human—Puts a certain human player on screen.
Tile—Changes a certain tile.
Gravity—Changes the gravity in this screen.
Msg—Displays a message (The text is taken from “description”).
Value—A parameter used in conjunction with the event “Type”:
Enemy—The serial number of the enemy type (−1=Random)
Item—The serial number of the item type (−1=Random)
Human—The serial number of the human player type (−1=Random)
Tile—The tile serial number to replace the tile in X, Y with.
Gravity—The new gravity value.
Msg—Unused (Future use: number of seconds to show message).
MAX—Don't trigger the event if more than MAX enemies/items/humans are already present.
MAXTIMES—The maximum number of times that this event can be triggered.
Repeat—Repeat this event “Repeat” times.
NextEvent—After running this event, trigger also the event number “NextEvent”.
Sound—The sound played when this event is triggered (0=None).
CUR_INT—Reserved (Used by engine to count time-ticks until next trigger).

Events can be added into a game in two ways: incorporating objects that trigger certain events, or just selecting interval-activated events in the events tab.

A sound object represents a single sound effect/music tune. This object holds:
The sound file—A binary stream.
The file type—An identifier for the file type (wav/midi etc.)
Loop count—How many times should the sound be repeated.
Vibration—Sets the length of vibration associated with the sound. (0=None).

The following sound formats are preferably supported:
Midi (audio/midi)
Wave (audio/x-wav)

### Tone Sequence (audio/x-tone-seq) The exact format of a tone sequence is described is the MMA API in the ToneControl class.

Au (audio/au)
MPEG Audio (Audio/mpeg)
3GPP Audio (audio/3gpp)
AMR (audio/amr)
AMR-WB (audio/amr-wb)
RMF (audio/x-beatnik-rmf)
Real (application/vnd.rn-realmedia)

There are two places were sounds can be found:
Game file—Each game can have its own sounds. The sounds can be referenced from any sound property.
Engine Wave Table—The client itself can also contain a default sounds table. This can be useful for defining common sound effects so they don't have to be downloaded each time. Only WAV is supported for the engine wave table. Referencing an engine wave table sound is done by supplying a negative integer in any sound property (−1 references the first, −2 the second and so on).

An intro is a video file that is played in the beginning of the game (Before the menu is shown). The intro is basically a sound object with a different file type. It is saved in a special place in the game file so it is recognized as the intro and not as another sound sample.

The supported video formats for the intro are:
video/mpeg
video/mp4
video/3gpp

A font object can be used to override the system default font (and default colors). The font will be used in the game menu and in the various game messages. In the example shown support is only provided for only one font per game, but it will be appreciated that support for more fonts may be added without departing from the scope of the invention.

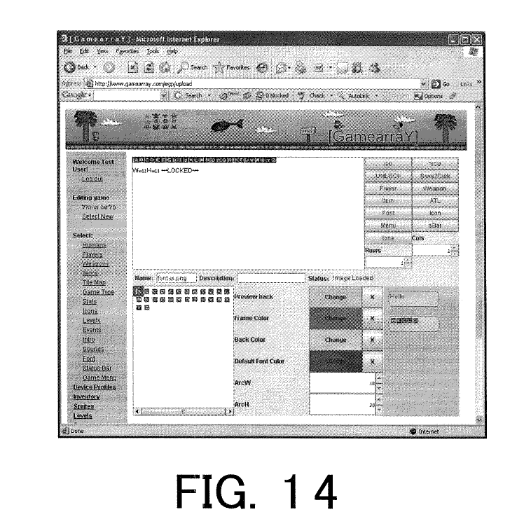

A font may include an image that contains tiles of the entire alphabet and digits. The order of the letters/numbers is significant tile-set should be A-Z and then 0-9. In the example shown, support is limited to A-Z, 0-9 but it may be expanded to support different char sets. The upload is done using the editing applet as shown in FIG. 14, which also allows changing the following properties:
(Preview Back)—This is not a real property, it is just used for preview purposes.
Frame Color—The color of the frame (For framed messages only).
Back Color—Background color (if applicable).
Default font color—This relates to the system font only, since the color of the font itself cannot be changed (it is a bitmap).
ArcW—The horizontal arc angle of the frame (0=no arc, straight).
ArcH—The vertical arc angle of the frame (0=no arc, straight).

If the font object does not include an image, then these properties (Colors and Arcs) operate on the system font, allowing some customization even with no bitmapped font.

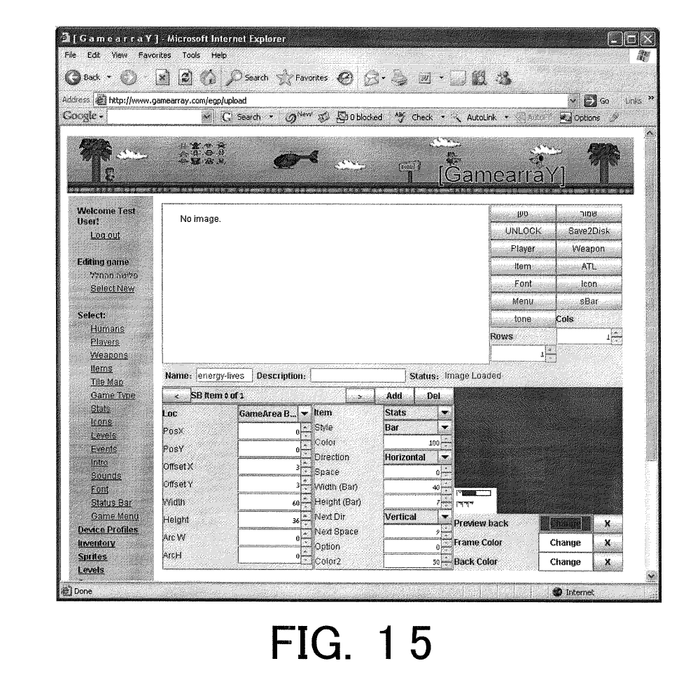

A status bar is a complex object that is used to display a player's stats and other properties to the user while the game is played. Due to its complexity, the status bar also requires use of the editing applet, as seen in FIG. 15. A status bar is composed of status bar items. Each item shows the status of a certain property of the player. One status bar can contain a lot of items that show different things (for example: The lives left, energy and current weapon). The status bar has general properties that relate to it as a whole, and also each item has its own properties that decide what this item shows and in what way.

The status bar general properties are:
Loc—The location of the status bar. Possible options are:
Bt Right/Top Right/Bt Left/Top Left—A horizontal status bar in the specified corner of the screen (Bottom/Top Right/Left).
Vert Bt Rt/Vert Top Rt/Vert Bt Lt/Vert Top Lt—A vertical status bar in the specified corner of the screen (Bottom/Top Right/Left).
GameArea . . . —A horizontal status bar in the specified corner of the game area (Bottom/Top Right/Left). The game area can be defined to be smaller than the screen. If the status bar location is chosen as “GameArea . . . ” it will always appear in the game area itself, while if it's not it will appear in the corner of the screen of the phone (can be outside the game area thus not covering it).
GameArea Vert . . . —A vertical status bar in the specified corner of the game area (Bottom/Top Right/Left).
Center—A status bar in the center of the screen (usually appears only upon an explicit request).
PosX—The horizontal position (from the chosen location).
PosY—The vertical position (from the chosen location). For example a status bar with a location of “Top Right”, “PosX” of 5 and “Pos Y” of 3, will start at 5,3. On the other hand a bar with a location of “Bt Left” and the same Pos X/Y will begin in ScreenWidth-Width-5, ScreenHeight-Height-3. (Width/Height are defined below).
OffsetX—The horizontal offset from the status bar left side. All status bar items will start at this offset.
OffsetY—The vertical offset from the status bar's top. All status bar items will start at this offset.
Width—The status bar's width.
Height—The status bar's height
Arc W—The angle (in degrees) of the status bar horizontal frame arc (0=None).
Arc H—The angle (in degrees) of the status bar vertical frame arc (0=None).

Other general properties determines the colors of the bar. These are:
(Preview Back)—Used in editor just for preview. Not saved as a property.
Frame Color—The frame color of the status bar. Can be transparent (No frame).
Back Color—The background color behind the bar. Can be transparent.

Another option is to upload an image to serve as the background of the Status bar. The image can also include alpha values so it would look semi-transparent and create a nice effect.

As said before these properties only define the general way the status bar is displayed as a whole. Aside from that, status bar items can be added, each one having these properties:
Item—This property defines which of the player's attributes this status bar item relates to. Possible options are:
Weapon—Current weapon held.
Clips—The number of clips the current weapon has.
Bullets—The number of bullets the current weapon has.
Item—Current item held.
Score—Current score.
Stats—The status of a certain stat.
Lives—Number of lives left.
Style—Defines the style in which the status bar item will be displayed:
Icons—Icon(s) will represent the selected item.
Bar—A bar will show the item's status (i.e. energy).
Digits—A number will be displayed (ideal for score, health points).
Piechart—Segments of different colors will be displayed.
Color—Defines the color of the status bar item. This is relevant only to certain styles, for example icon is not affected, while bar uses it for the bar color. Digits use it to for the font color (unless the font chosen is a bitmapped font).
Direction—Defines the direction of the status bar item.
Horizontal—Shown horizontally from left to right.
Vertical—Shown vertically downwards.
Horiz RTL—Shown horizontally from right to left.
Vert DTU—Shown vertically upwards.
Space—The spacing used between elements in this item. For example if clips are being shown using icons and there are 3 clips, it would be preferable to have some spacing between these icons.
Width (Bar)—The width of this status bar item (applies mostly to bar style).
Height (Bar)—The height of this status bar item (applies mostly to bar style).
Next Dir—Defines where to locate the next item:
Horizontal—Next to this one
Vertical—Below this one.
Next Space—Defines the spacing between this item and the next.
Option—A parameter. Used when displaying a stat to choose the stat index.
Color2—A second color. Used in bar to determine the frame color.

An icon is a rather simple object that is composed of a single static image. Icons are used in the Status bar to represent certain properties (Such as lives, stats, weapons, bullets etc.). An icon is created by simply uploading an image using the editing applet (And defining it as an icon on upload).

A game menu is an object that defines the game poster screen and its menu. The menu commands are displayed on the poster screen. Each menu command is composed of the following properties:
Title—The title of this menu command.
Description—A description of what the command does (optional).
Icon—An icon can be used to show an image instead of simple text.
Command code—Determines what will be done when this is selected.

The supported command codes are:
Run—Run a game.
Resume—Resume a saved game.
Exit—Exit game (to main games menu)
Controls—Show keyboard controls.
Help—Show the help screen.
About—Show the about screen.
Info—Show Help, then Controls, then About.
Intro—Show intro (again).

If icons are not used, the font used is the selected font object (if it exists), or the system default font. Coloring is done according to the font's colors, and if a poster screen exists, all textual items will not have backgrounds, but will just be displayed on the poster screen.

In this example, the only editable property of a game menu is its image. Once an image is uploaded using the editing applet and tagged as a game menu, the editor automatically creates a game menu that includes the uploaded image as a poster screen and a constant set of default commands.

The commands that are shown in this example are:
Start—Executes the “Run” command
Instructions—Executes the “All Info” command.
Exit—Executes the “Exit” command.

These commands don't use icon, but just simple text (Start etc.).

Content can be derived automatically for different devices according to the device capabilities. This is done by defining different device profiles. A device profile object defines the properties for a certain profile, which can include one or more devices. This object doesn't need to be defined per game, but only once in a lifetime of a device. It is not closely related to the editing process itself, but mentioned here for clarity. The profile should be defined according to the device capabilities (multimedia support, memory, screen size/colors etc.). The properties of these are:
General—Sets the general and most important properties for deriving content for this specific profile:
Shrink horizontally by—Shrinks all graphics by the factor specified (denoted as a percentage). While this feature is entirely functional, it is not commonly used since shrinking pixel-art is not effective. However this may be used for shrinking game posters, or for vector graphics.
Shrink vertically by—Shrinks all graphics by the factor specified (denoted as a percentage).
Colors—Denotes the number of colors this profile supports. The platform will render the pictures so they will be use the minimum amount of memory that is most effective for the device (There's no point in sending a 16M picture to a device that supports only 4K colors).
Font—Determines whether a non-system (bitmapped) font should be downloaded, or the system default font should just be used.
Menu—Determines whether a specialized menu (with a poster screen) will be downloaded (if defined for the game).
Status Bar—Determines whether to use a status bar for games. Status bar is problematic in small screens, since it occupies a lot of the game area.
Secondary Layers—Determines whether to download back/front layers or not. These layers may consume a lot of the device memory and storage space since they tend to be rich in graphics. They can be removed without affecting game functionality and be replaced with a background color.
Intro—Determines whether to download the video intro (if any).
Sound Support—This property set defines which sound (and video) formats are supported. When downloading a game all supported formats will be left as is. Sounds/videos from an unsupported type will be omitted, or replaced by an alternative supported file.
Stand Alone JAR—This property set is relevant for building standalone games. Complete midlets (mobile applications) can also be built that can operate without the platform. In these cases, besides deriving specific content, an adapted version of the code itself is also created, according to:
MIDP Version—The MIDP Version of the device (1 or 2).
Sound API—The supported sound API (None/MMA/Nokia).
Build Type—Standard or Nokia series 40.

A further option is the ability to preview the game on-line. This requires an additional page that contains an image of a generic phone, for example, and the game runs within its “screen” (with some limitations).

The following tables list keyboard shortcuts for use in the above example.

TABLE A

| | |
|---|---|
| Key | Description |

Editing Applet Keyboard Shortcuts

| | |
|---|---|
| + | Zoom in |
| − | Zoom out |
| ] | Increase horizontal spacing |
| [ | Decrease horizontal spacing |
| Z | Increase vertical spacing |
| A | Decrease vertical spacing |
| X | Adds/Removes an horizontal mirror |
| Y | Adds/Removes a vertical mirror |
| . (>) | Multiplies tile width by 2 |
| , (<) | Divides tile width by 2 |
| ′ | Multiplies tile height by 2 |
| ; | Divides tile height by 2 |
| L | Moves tile border to the left |
| J | Moves tile border to the right |
| I | Moves tile border up |
| K | Moves tile border down |
| 4 | Decreases tile width |
| 6 | Increases tile width |
| 8 | Decreases tile height |
| 2 | Increases tile height |
| 3 (PgDn) | Increases horizontal offset |
| 9 (PgUp) | Decreases horizontal offset |
| 1 (End) | Increases vertical offset |
| 7 Home | Decreases vertical offset |
| Left | Scrolls left |
| Right | Scrolls right |
| Up | Scrolls up |
| Down | Scrolls down |
| A | Moves cursor one tile to the left |
| D | Moves cursor one tile to the right |
| W | Moves cursor one tile up |
| S | Moves cursor one tile down |
| Enter | Select current frame |
| F11 | Auto-find |
| Rt.Clk | Right click on a certain pixel renders all pixels of the same |
| | color transparent |
| F1 | Make player |
| F2 | Make Weapon |
| F3 | Make Item |
| F4 | Make ATL (Abstract Tiled Layer) |
| F5 | Make Font |
| F6 | Make Icon |
| F7 | Make Menu |
| F8 | Make Status Bar |
| F9 | Make Sound |
| ESC | Load new file |
| R | Adds a rotated (90 degrees) tile-set |
| M | Adds a shadowed tile-set |
| 5 | Sets horizontal/vertical tile border to 0 |
| N | Adds an empty frame |

Keyboards shortcuts after image is locked:

| | |
|---|---|
| F1 | Previous direction |
| F2 | Next direction |
| F3 | Add current tile to all dirs in current mode |
| F4 | Add all tiles to all dirs in current mode. |
| F5 | Make Font |
| F6 | Make Icon |
| F7 | Delete current direction |
| F8 | Add a new direction |
| F9 | Delete current mode |
| F10 | Add a new mode |
| Space | Adds a null frame (empty frame) to all dirs in current mode |

TABLE B
Level Editor Keyboard Shortcuts

| Key | Description |
|---|---|
| 1 | Tiles mode |
| 2 | Players mode |
| 3 | Items mode |
| 4 | Patterns mode |
| 5 | Delete mode (Applies only for players/items) |
| 6 | Pattern grabbing mode |
| S | Switch between tiles/players/items/patterns etc. |
| D | Expand pattern to the right |
| A | Expand pattern to the left |
| X | Expand pattern downwards |
| W | Expand pattern upwards |
| Del | Delete Tile |
| F1 | Save |
| F2 | Toggle Animation |
| F3 | Change color |
| F4 | Exit |
| F5 | Resize |
| F6 | Show/Stop |
| Arrows | Move cursor to all directions |

The above example may be modified to add multiplayer support and 3D without departing from the scope of the invention.

Although the preferred embodiments as described above relate to games, it will be understood by those skilled in the art that the invention is capable of application to software in general, and that the game file may more generally be a data file storing information relating to a software applet, just as the principles of the game editor may be applied to an editor for other types of software than games, and the game management system may also be used to manage other types of software.

It will be apparent to one skilled in the art that the manner of making and using the claimed invention has been adequately disclosed in the above-written description taken together with the drawings.

It will be understood that the above description of the preferred embodiments are susceptible to various modifications, changes and adaptations, and the same are intended to be comprehended within the meaning and range of equivalence of the appended claims.

What is claimed is:

1. A computer program product for a client application for a mobile device, comprising a computer storage medium having a computer program code mechanism embedded in the computer storage medium, said computer program code mechanism further comprising:
an engine configured to employ a data file storing information defining an applet, said information being stored in said data file in a standard format configured to be employed by a plurality of types of said mobile device; and
a code layer intervening between said engine and said mobile device, said code layer being configured for said engine to execute said applet on said mobile device, said code layer being further configured for use with at least one type of said mobile device selected from said plurality of types of said mobile device.

2. The computer program product according to claim 1, said information being stored in said data file comprising graphics, sounds and rules.

3. The computer program product according to claim 1, further comprising a builder that selects at least one code part for use in a build of said code layer for said at least one type of said mobile device selected from said plurality of types of said mobile device, according to whether a specific capability is provided in said at least one type of said mobile device.

4. The computer program product according to claim 1, wherein said data file is configured to be employed in certain types of said plurality of types of said mobile device provided with specific capabilities.

5. The computer program product according to claim 1, said mobile device comprising a virtual machine.

6. The computer program product according to claim 1, said mobile device comprising a telephone.

7. The computer program product according to claim 1, said computer program code mechanism further comprising:
a management system for selecting and downloading said data file from a server.

8. The computer program product according to claim 7, wherein:
said data file is downloaded to and stored in a Record Management System (RMS) memory of said mobile device.

9. A computer program product for a server application, comprising a computer storage medium having a computer program code mechanism embedded in the computer storage medium, said computer program code mechanism further comprising:
an editor configured to edit a data file; and
a download server configured to download said data file to a mobile client.

10. The computer program product according to claim 9, wherein:
said editor is accessible by a user via a web browser.

11. The computer program product according to claim 9, wherein:
said editor is configured to create said data file as a new data file;
said editor is configured to select a type of game to be represented by said new data file; and
said editor is configured to select parameters of said game from at least one menu.

12. The computer program product according to claim 11, wherein:
said editor is configured to edit graphical files for use in said game.

13. The computer program product according to claim 12, wherein:
said editor is configured to grab images from a screen for use in said graphical files.

14. The computer program product according to claim 11, wherein:
said editor is configured to preview the game.

15. The computer program product according to claim 9, wherein:
said download server downloads said data file to a Record Management System (RMS) memory of said mobile device.

16. The computer program product according to claim 9, said download server granting permission to download said data file only to a first user that created said data file and to any additional user invited to download said data file by said first user.

17. A computer program product comprising a computer storage medium having a computer program code mechanism embedded in the computer storage medium, the computer program code mechanism performing the steps of:
editing a data file according to input from a user; and
downloading said data file from a server to a mobile client.

18. The computer program product according to claim 17 said computer program code mechanism further performing the steps of:
displaying parameters of said data file in a web browser; and
accepting said input from said user via an HTTP operation.

19. The computer program product according to claim 17, said computer program code mechanism further performing the steps of:
creating said data file as a new data file;
selecting a type of game to be represented by said new data file; and
selecting parameters of said game from at least one menu.

20. The computer program product according to claim 19, said computer program code mechanism further performing the step of:
editing graphical files for use in said game.

21. The computer program product according to claim 20, said computer program code mechanism further performing the step of:
grabbing images from a screen for use in said graphical files.

21. The computer program product according to claim 17, wherein:
said step of downloading said data file from said server to said mobile client comprises downloading said data file to a Record Management System (RMS) memory of said mobile device.

22. The computer program product according to claim 17, said computer program code mechanism further performing the step of:
granting permission to download said data file only to a first user that created said data file and to any additional user invited to download said data file by said first user.

23. The computer program product according to claim 17, said computer program code mechanism further performing the step of:
selecting said data file according to capabilities of said mobile client.
